(19) United States
(12) Patent Application Publication
(10) Pub. No.: US 2016/0217262 A1
(43) Pub. Date: Jul. 28, 2016

(54) Medical Imaging Region-of-Interest Detection Employing Visual-Textual Relationship Modelling.

(71) Applicant: International Business Machines Corporation, Armonk, NY (US)

(72) Inventors: Hashoul Sharbell, Haifa (IL); Pavel Kisilev, Maalot (IL); Asaf Tzadok, Nesher (IL); Eugene Walach, Haifa (IL)

(21) Appl. No.: 14/604,801

(22) Filed: Jan. 26, 2015

(51) Int. Cl. G06F 19/00; G06K 9/62; G06N 99/00

(52) U.S. Cl. CPC G06F 19/345; G06F 19/322; G06F 19/321; G06N 99/005; G06K 9/6217

(57) ABSTRACT

Detecting regions-of-interest in medical images by identifying one or more image features in one or more medical images of a subject patient, identifying one or more clinical descriptors within clinical records of the subject patient, and identifying, using a visual-textual relationship model, regions-of-interest within the medical images of the subject patient based on relationships within the visual-textual relationship model corresponding to relationships between the image features identified in the subject patient medical images and the clinical descriptors identified in the subject patient clinical records.

### BACKGROUND

Breast cancer accounts for about 30% of all diagnosed cancers in women, and is the second leading cause of death in women worldwide. Mammography is currently the most common modality for screening and detecting breast cancer. However, breast lesions found in mammograms are often benign. To improve the specificity, doctors often examine suspicious lesions using ultrasound (US) imaging. Ultrasound is also known to increase cancer detection sensitivity, in particular for women with dense breasts. However, it is an operator-dependent modality, and US image interpretation varies depending on the expertise of the radiologist. In order to reduce operator-dependent diagnosis variability and increase diagnosis accuracy, computer-aided detection and diagnosis (CAD) systems have been developed for breast cancer detection and classification. CAD systems typically perform image enhancement, region-of-interest (ROI) detection, feature extraction from ROIs, and classification. Unfortunately, US CAD efficacy is often limited by incorrect automatic detection and localization of lesions, and a lack of robustness of calculated features.

### SUMMARY

In one aspect of the invention a method is provided for detecting regions-of-interest in medical images by identifying one or more image features in one or more medical images of a subject patient, identifying one or more clinical descriptors within clinical records of the subject patient, and identifying, using a visual-textual relationship model, regions-of-interest within the medical images of the subject patient based on relationships within the visual-textual relationship model corresponding to relationships between the image features identified in the subject patient medical images and the clinical descriptors identified in the subject patient clinical records.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIGS. 1A and 1B, taken together, is a simplified conceptual illustration of a medical imaging region-of-interest detection system, constructed and operative in accordance with an embodiment of the invention

FIG. 2A is a simplified flowchart illustration of an exemplary method of operation of the system of FIG. 1A, operative in accordance with an embodiment of the invention;

FIG. 2B which is a simplified flowchart illustration of an exemplary method of operation of the system of FIG. 1B, operative in accordance with an embodiment of the invention; and

FIG. 3 is a simplified block diagram illustration of an exemplary hardware implementation of a computing system, constructed and operative in accordance with an embodiment of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

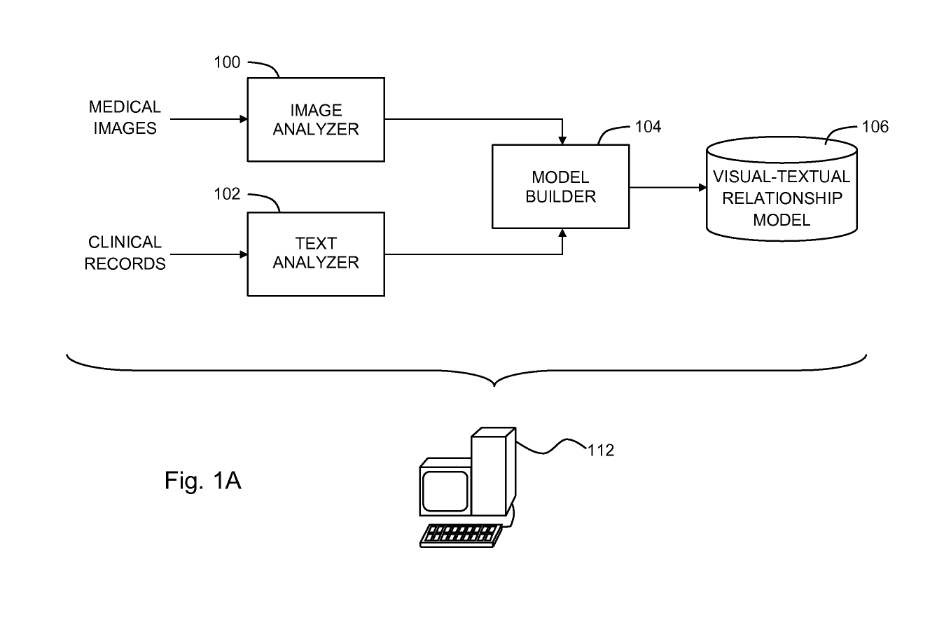

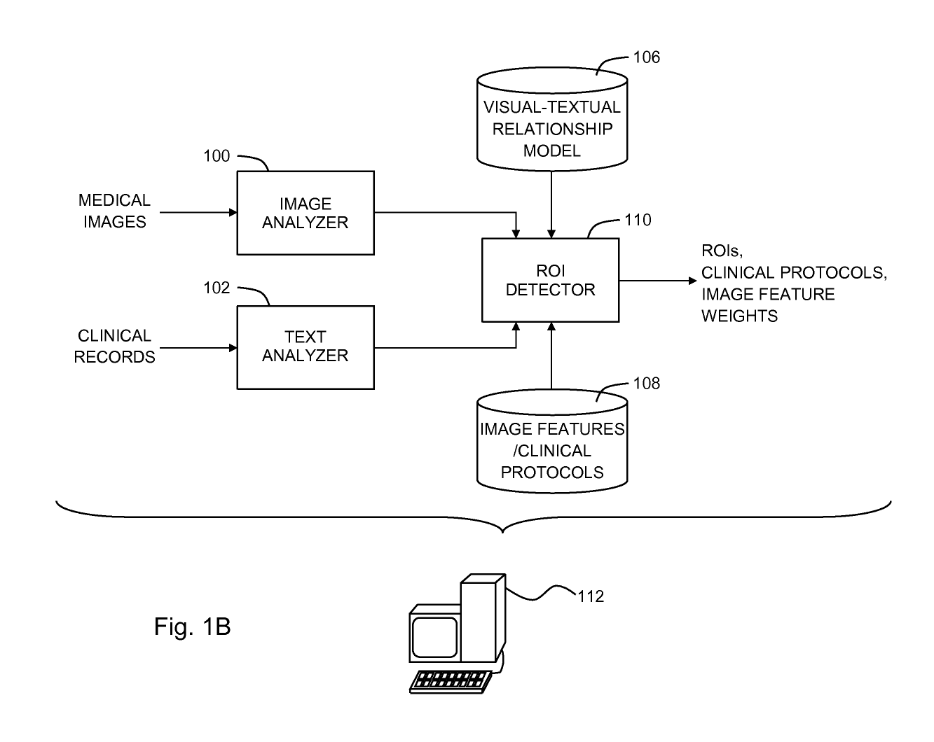

Reference is now made to FIGS. 1A and 1B which, taken together, is a simplified conceptual illustration of a medical imaging region-of-interest detection system, constructed and operative in accordance with an embodiment of the invention. In the system of FIG. 1A, medical images, such as ultrasound images, of a patient who has been diagnosed with a disease and that include identified regions-of-interest (ROIs) that have been determined to be symptoms of the disease in that patient, are provided in a computer-readable image format to a computer-based image analyzer 100 which identifies image features in accordance with conventional techniques, such as in accordance with the methods described by P. Kisilev, E. Barkan, G. Shakhnarovich, and A. Tzadok in “Learning to detect lesion boundaries in breast ultrasound images”, Breast Imaging Workshop, MICCAI 2013. Image analyzer 100 preferably identifies image features including shape, acoustic transmission, margins, echogenicity, and intensity and texture, in accordance with the following considerations:
Shape. Malignant tumors tend to have more irregular and lobular shapes. To evaluate this, calculations are made of features such as the area of the mass, its aspect ratio, and the curvature along the mass boundaries. Additional shape features are calculated by fitting an ellipse to the mass borders to determine the ellipse orientation, the ratio between the minor and the major axes, and various distances (e.g., L1 norm, the maximal distance, etc.) between the mass border and the ellipse.
Acoustic transmission. The posterior of the mass is an important characteristic when assessing the risk of malignancy. Strong enhancement and edge shadowing are common in benign masses, such as cysts, while posterior shadowing is common in malignant tumors. In order to assess the level of the posterior enhancement/shadowing, the area below the mass is examined, and calculations are made of the ratios of the median intensities and intensity variances inside its different segments.
Margins. Sharp margins may indicate a benign tumor, and vice versa. To assess the sharpness of the boundaries, the mass is divided into 8 sectors of 45 degrees, and calculations are made to determine a measure of sharpness of the boundary in each sector. The overall sharpness feature is the median of the 8 values.
Echogenicity. Another important characteristic of masses examined by doctors is their echogenicity compared to fat tissue, as high values may indicate malignancy. Echogenicity and mass uniformity are also useful for diagnosis of specific types of tumors. In order to quantify these features, various heuristics are used to recognize the fat tissue which is located on the upper side of ultrasound images.
Intensity and texture. To describe texture content of the ROI, local entropy is computed at three different scales. Two normalized intensity histograms are calculated of the inner and the outer (i.e., next to the boundary) areas of the ROI.

Clinical records of the patient are provided in a computer-readable text format to a computer-based text analyzer 102, which identifies clinical descriptors within the clinical records in accordance with conventional techniques, such as in accordance with the methods described by P. Kisilev, S. Hashoul, E. Walach, and A. Tzadok in “Lesion classification using clinical and visual data fusion by multiple kernel learning,” SPIE Medical Imaging 2014, (hereinafter “Kisilev2”).

The image features identified by image analyzer 100, as well as the clinical descriptors identified by text analyzer 102, are provided in a computer-readable format to a computer-based model builder 104 which identifies relationships between the image features and the clinical descriptors and builds a visual-textual relationship model 106 of these relationships. Model builder 104 preferably employs Multiple Kernel Learning to train a Support Vector Machine classifier, such as in accordance with the methods described by Kisilev2, where parameters of the kernels and the weights of the kernels are trained on a set of training images such that the trained parameters minimize any expected error, and where a weight represents an importance value associated with a type of image feature or a reliability value for characterizing an image feature in a correct manner and for discriminating the specific type of image feature from the other types of image features.

Model builder 104 is optionally configured to utilize other relationships 108 between image features and clinical protocols to create within visual-textual relationship model 106 new relationships between clinical descriptors and the clinical protocols. For example, if there is a known relationship associating bright image features with the use of a particular malignancy detector that is suited to the analysis of images having bright image features, if a clinical descriptor in the clinical records, such as the word “fever,” is determined to be correlated with bright image features, then model builder 104 preferably creates within visual-textual relationship model 106 a relationship between the clinical descriptor “fever” and the clinical protocol of using the particular malignancy detector.

The system of FIG. 1A preferably operates as described above on medical images and clinical records associated with multiple patients, where the images include ROIs that have been determined to be symptoms of diagnosed diseases, thereby providing model builder 104 with a learning set of patient information that model builder 104 uses to build visual-textual relationship model 106.

In contrast, the system of FIG. 1B may operate as follows to detect ROIs in medical images of a patient by employing visual-textual relationship model 106. In the system of FIG. 1A, medical images of a patient are provided in a computer-readable format to image analyzer 100, which identifies image features as described above, and clinical records of the patient are provided in a computer-readable format to text analyzer 102, which identifies clinical descriptors within the clinical records as described above. The image features identified by image analyzer 100, as well as the clinical descriptors identified by text analyzer 102, are provided in a computer-readable format to a computer-based ROI detector 110 which uses visual-textual relationship model 106 to identify ROIs within the medical images based on the relationships of the image features and clinical descriptors within visual-textual relationship model 106. ROI detector 110 preferably reports the identified ROIs, such as to a clinician, in accordance with conventional techniques. Where visual-textual relationship model 106 includes relationships between clinical descriptors and clinical protocols, ROI detector 110 preferably uses visual-textual relationship model 106 to identify the clinical protocols based on the input clinical descriptors and report the identified clinical protocols as well. Additionally or alternatively, ROI detector 110 uses visual-textual relationship model 106 to retrieve weights for identified image features, where the weights were previously determined by model builder 104 during the training stage described hereinabove, and then ROI detector 110 preferably reports the weights, such as to a clinician, in accordance with conventional techniques.

Any of the elements shown in FIGS. 1A and 1B are preferably implemented by one or more computers, such as by a computer 112, in computer hardware and/or in computer software embodied in a non-transitory, computer-readable storage medium in accordance with conventional techniques.

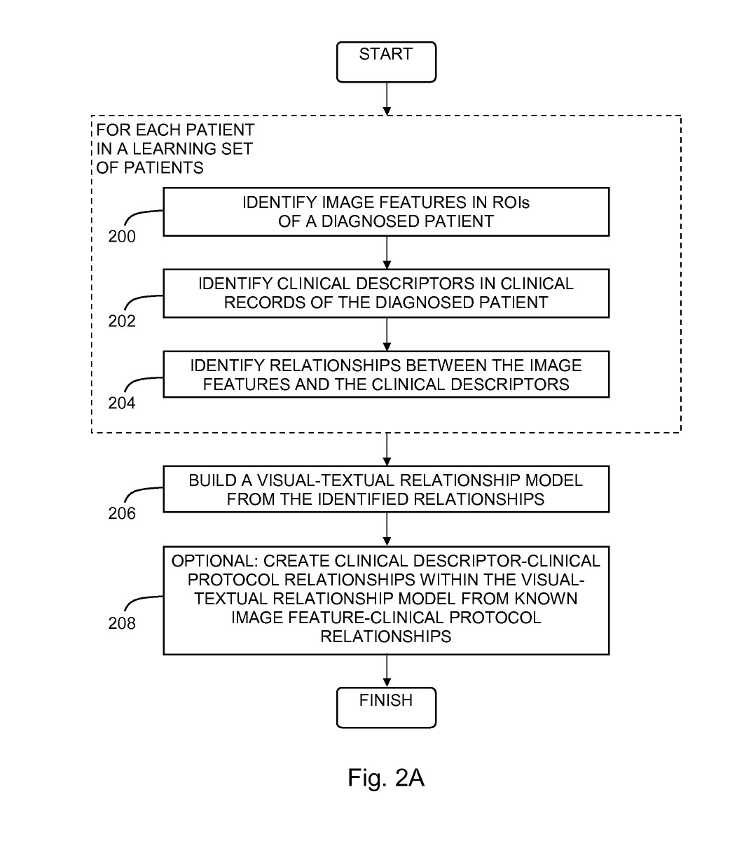

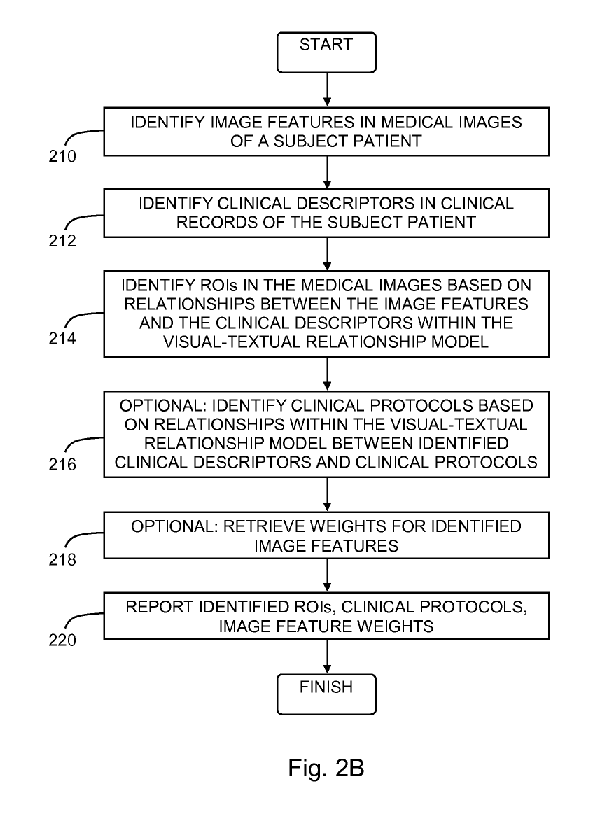

Reference is now made to FIG. 2A which is a simplified flowchart illustration of an exemplary method of operation of the system of FIG. 1A, operative in accordance with an embodiment of the invention. In the method of FIG. 2A, image features are identified in medical images of a patient who has been diagnosed with a disease and that include identified regions-of-interest (ROIs) that have been determined to be symptoms of the disease in that patient (step 200). Clinical descriptors are identified in clinical records of the patient (step 202). Relationships are identified between the image features and the clinical descriptors (step 204). Steps 200-204 are preferably performed multiple times for medical images and clinical records associated with multiple patients which represent a learning set of patients. A visual-textual relationship model is built of these relationships (step 206), preferably where Multiple Kernel Learning is employed to train a Support Vector Machine classifier, where parameters of the kernels and the weights of the kernels are trained on a set of training images such that the trained parameters minimize any expected error. Optionally, relationships between clinical descriptors and clinical protocols are created within visual-textual relationship model based on known relationships between image features and the clinical protocols (step 208).

Reference is now made to FIG. 2B which is a simplified flowchart illustration of an exemplary method of operation of the system of FIG. 1B, operative in accordance with an embodiment of the invention. In the method of FIG. 2B, image features are identified in medical images of a subject patient (step 210), and clinical descriptors are identified in clinical records of the subject patient (step 212). ROIs are identified within the medical images based on the relationships of the image features and clinical descriptors within the visual-textual relationship model built using the method of FIG. 2A (step 214). Clinical protocols are optionally identified based on the input clinical descriptors where the visual-textual relationship model includes relationships between clinical descriptors and clinical protocols (step 216). Weights for identified image features are optionally retrieved from the visual-textual relationship model (step 218). Any of the identified ROIs, clinical protocols, and weights are reported (step 220).

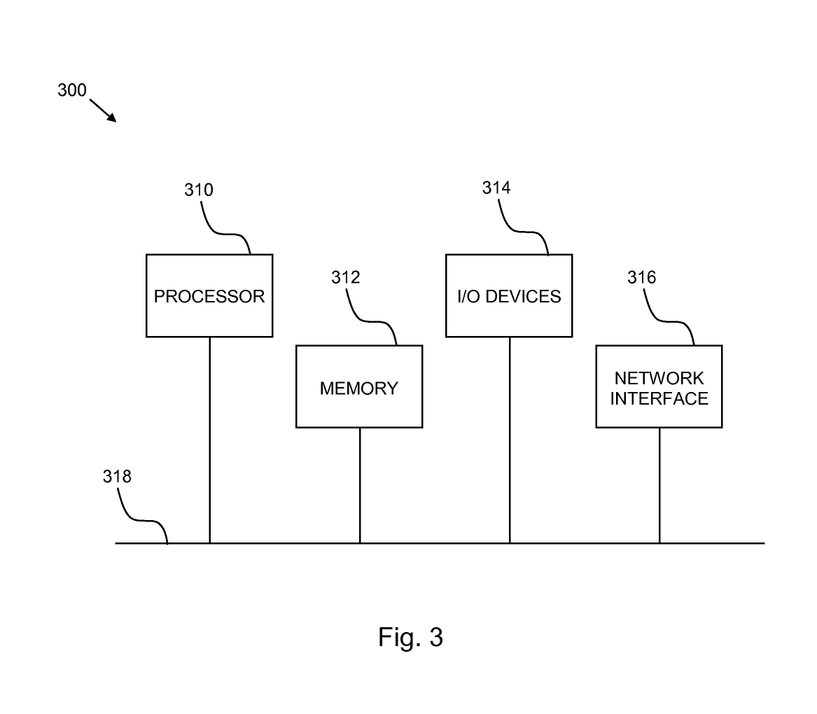

Referring now to FIG. 3, block diagram 300 illustrates an exemplary hardware implementation of a computing system in accordance with which one or more components/methodologies of the invention (e.g., components/methodologies described in the context of FIGS. 1A-2B) may be implemented, according to an embodiment of the invention.

As shown, the techniques for controlling access to at least one resource may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for detecting regions-of-interest in medical images, the method comprising:
identifying one or more image features in one or more medical images of a subject patient;
identifying one or more clinical descriptors within clinical records of the subject patient; and
identifying, using a visual-textual relationship model, regions-of-interest within the medical images of the subject patient based on relationships within the visual-textual relationship model corresponding to relationships between the image features identified in the subject patient medical images and the clinical descriptors identified in the subject patient clinical records.

2. The method according to claim 1 wherein the identifying image features comprises identifying at a computer-based image analyzer wherein the medical images are in a computer-readable image format.

3. The method according to claim 1 wherein the identifying clinical descriptors comprises identifying at a computer-based text analyzer wherein the clinical records are in a computer-readable text format.

4. The method according to claim 1 wherein the identifying regions-of-interest comprises identifying at a computer-based region-of-interest detector wherein the image features and clinical descriptors are in a computer-readable format.

5. The method according to claim 1 and further comprising constructing the visual-textual relationship model by
identifying, for each learning set patient in a learning set of patients,
one or more image features in one or more medical images of the learning set patient who has been diagnosed with a disease, where the medical images include identified regions-of-interest that have been determined to be symptoms of the disease in the learning set patient,
one or more clinical descriptors within clinical records of the learning set patient, and
relationships between the image features identified in the learning set patient medical images and the clinical descriptors identified in the learning set patient clinical records, and
representing within the visual-textual relationship model the relationships between the image features identified in the learning set patient medical images and the clinical descriptors identified in the learning set patient clinical records.

6. The method of claim 1 wherein the identifying is implemented in any of
a) computer hardware, and
b) computer software embodied in a non-transitory, computer-readable medium.

7. A system for detecting regions-of-interest in medical images, the system comprising:
a computer-based image analyzer configured to identify one or more image features in one or more medical images of a subject patient;
a computer-based text analyzer configured to identify one or more clinical descriptors within clinical records of the subject patient; and
a computer-based region-of-interest detector configured to identify, using a visual-textual relationship model, regions-of-interest within the medical images of the subject patient based on relationships within the visual-textual relationship model corresponding to relationships between the image features identified in the subject patient medical images and the clinical descriptors identified in the subject patient clinical records.

8. The system according to claim 7 wherein the medical images are in a computer-readable image format.

9. The system according to claim 7 wherein the clinical records are in a computer-readable text format.

10. The system according to claim 7 wherein the image features and clinical descriptors are in a computer-readable format.

11. The system according to claim 7 and further comprising a computer-based model builder configured to construct the visual-textual relationship model by
identifying, for each learning set patient in a learning set of patients,
one or more image features in one or more medical images of the learning set patient who has been diagnosed with a disease, where the medical images include identified regions-of-interest that have been determined to be symptoms of the disease in the learning set patient,
one or more clinical descriptors within clinical records of the learning set patient, and
relationships between the image features identified in the learning set patient medical images and the clinical descriptors identified in the learning set patient clinical records, and
representing within the visual-textual relationship model the relationships between the image features identified in the learning set patient medical images and the clinical descriptors identified in the learning set patient clinical records.

12. The system of claim 7 wherein the image analyzer, text analyzer, and region-of-interest detector are implemented in any of
a) computer hardware, and
b) computer software embodied in a non-transitory, computer-readable medium.

13. A computer program product for detecting regions-of-interest in medical images, the computer program product comprising:
a non-transitory, computer-readable storage medium; and
computer-readable program code embodied in the storage medium, wherein the computer-readable program code is configured to
identify one or more image features in one or more medical images of a subject patient,
identify one or more clinical descriptors within clinical records of the subject patient, and
identify, using a visual-textual relationship model, regions-of-interest within the medical images of the subject patient based on relationships within the visual-textual relationship model corresponding to relationships between the image features identified in the subject patient medical images and the clinical descriptors identified in the subject patient clinical records.

14. The computer program product according to claim 13 wherein the medical images are in a computer-readable image format.

15. The computer program product according to claim 13 wherein the clinical records are in a computer-readable text format.

16. The computer program product according to claim 13 wherein the image features and clinical descriptors are in a computer-readable format.

17. The computer program product according to claim 13 wherein the computer-readable program code is configured to construct the visual-textual relationship model by
identifying, for each learning set patient in a learning set of patients,
one or more image features in one or more medical images of the learning set patient who has been diagnosed with a disease, where the medical images include identified regions-of-interest that have been determined to be symptoms of the disease in the learning set patient,
one or more clinical descriptors within clinical records of the learning set patient, and
relationships between the image features identified in the learning set patient medical images and the clinical descriptors identified in the learning set patient clinical records, and
representing within the visual-textual relationship model the relationships between the image features identified in the learning set patient medical images and the clinical descriptors identified in the learning set patient clinical records.
